(19) United States
(12) Patent Application Publication
(10) Pub. No.: US 2007/0172089 A1
(43) Pub. Date: Jul. 26, 2007

(54) Headset assembly

(76) Inventor: Li-Wen Kuo, Chung Ho City (TW)

Correspondence Address: BIRCH STEWART KOLASCH & BIRCH, PO BOX 747, FALLS CHURCH, VA, 22040-0747, US

(21) Appl. No.: 11/335,560

(22) Filed: Jan. 20, 2006

(51) Int. Cl. H04R 25/00

(52) U.S. Cl. 381/370

(57) ABSTRACT

A headset assembly comprises a main body, connecting mechanism and a container. The main body comprises two hanging portions and a storage portion. The hanging portions are bent to adjust the main body size for fitting a wearer. The connecting mechanism provides the main body to connect to the container. Moreover, the container is rotatable in the storage portion for adjusting a power line.

### BACKGROUND OF THE INVENTION

1. Field of the Invention

The present invention relates to a headset assembly, and in particular relates to a headset assembly for comprising a microphone and an earphone.

2. Description of the Related Art

The applicant has been awarded a Taiwan patent for a “headset assembly” (Taiwan patent No. 484785). Referring to FIGS. 1 and 2, the headset assembly 10 comprises a main body 11, a connecting mechanism 12 and a container 13. A storage portion 131 of the main body 11 is not ringlike, thereby the container 13 is not rotated in the main body 11. Because the container 13 is not rotated, a power line 14 of a microphone/an earphone is not moved to a position suitable for hiding. If a military, police officer or a security guard wears the headset, the power line 14 may be exposed giving away its position potentially endangering the wearer. Moreover, the main body 11 and a hanging portion 111 are a single and unitary member. A wearer cannot bend the enclosed type headset assembly 10 to change the shape of the hanging portion 111 for fitting each wearer, thus, the headset assembly 10 cannot be personalized. Moreover, if the headset assembly 10 is worn for a prolonged period, the wearer may experience discomfort.

### BRIEF SUMMARY OF INVENTION

A detailed description is given in the following embodiments with reference to the accompanying drawings. A headset assembly comprises a main body, a connecting mechanism and a container. The main body comprises two hanging portions and a storage portion. The hanging portions are bend able changing for the shape and the size of the main body. The storage portion comprises a plurality of holes. The connecting mechanism comprises a first connecting element and a second connecting element. The first connecting element comprises a plurality of protrusions. The second connecting element comprises a plurality of apertures. The protrusions pass through the holes and the apertures for fixing the first connecting element and second connecting element. The container comprises a base and a cover. The base passes through the connecting mechanism and main body to connect to the cover.

The storage portion of the headset assembly has ringlike shape enabling rotation of the container.

### BRIEF DESCRIPTION OF DRAWINGS

The present invention can be more fully understood by reading the subsequent detailed description and examples with references made to the accompanying drawings, wherein:

FIG. 1 is a schematic view showing a conventional headset assembly;

FIG. 2 is a schematic view showing a main body of the conventional headset assembly;

FIG. 3 is a schematic view showing a headset assembly of the invention;

FIG. 4 is an explosion view showing a headset assembly of the invention;

FIG. 5 is a schematic view showing the other side of a first connecting element in FIG. 4; and

FIG. 6 is a schematic view showing the other side of a second connecting element in FIG. 4.

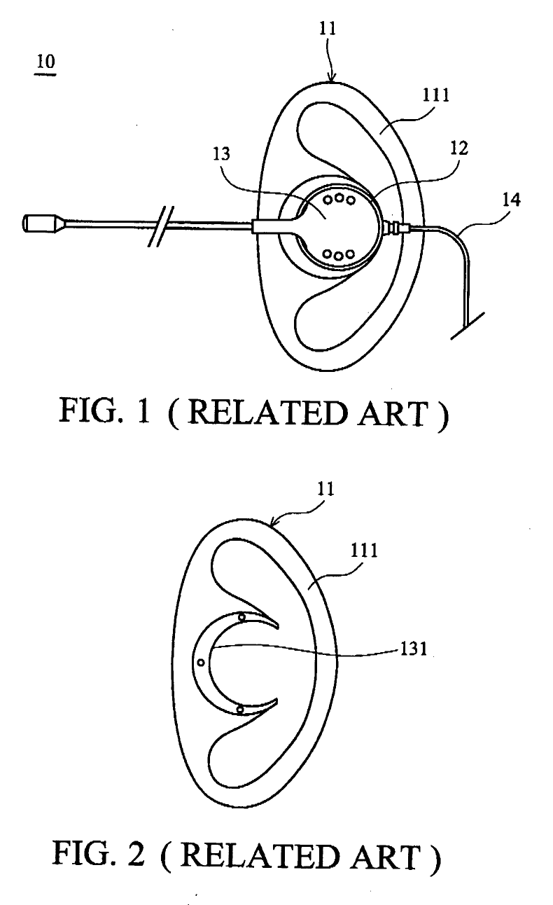

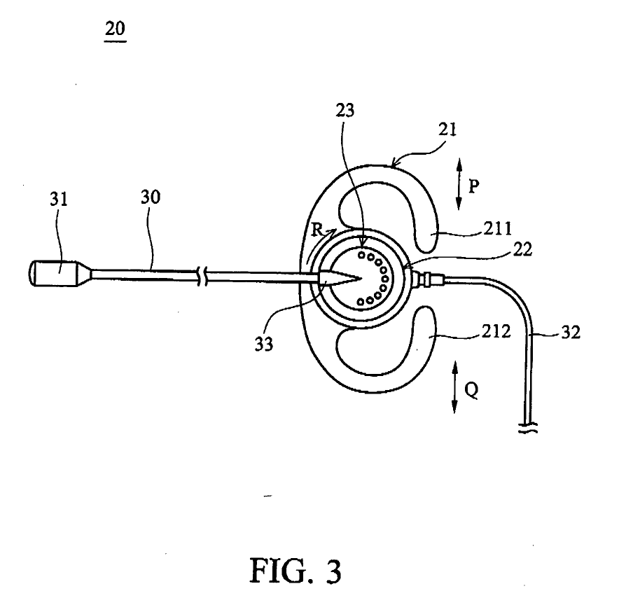

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

A headset assembly 20 comprises a main body 21, a connecting mechanism 22, a container 23, a tube 30, a microphone 31 and a power line 32. The container 23 comprises a hole 33 to connect to the tube 30 and the microphone 31. In this embodiment, the hanging portions 211 and 212 are bent along arrows P and Q to change the shape thereof. The shape of the hanging portions 211 and 212 bent to comfortably fit the ear of a wearer. In this embodiment, the main body 21 is made of rubber, wherein after the hanging portions 211 is bent, the hanging portions 211 maintain the bent shape. The container 23 rotates along an arrow R in the connecting mechanism 22 and the main body 21 for moving the power line 32. If a military, police or security guard wears the headset, the power line 32 is easily hidden to avoid giving away its position. Because the tube 30 is flexible, a wearer adjusts the microphone 31 by rotating the container 23 and bending the tube 30.

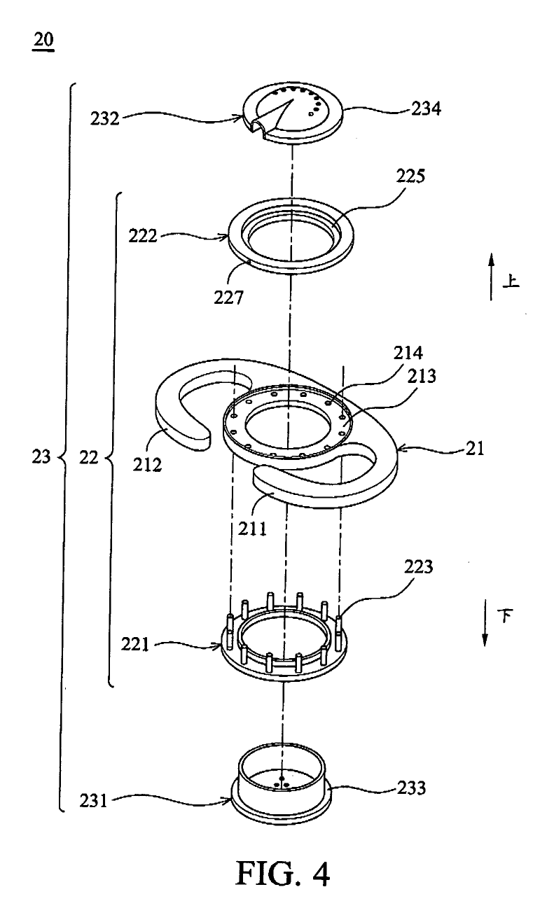

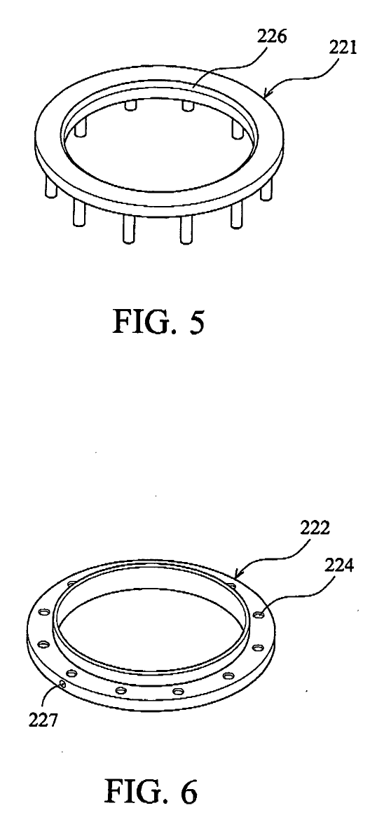

Referring to FIG. 4, the main body 21 comprises two hanging portions 211 and 212 and a storage portion 213. The hanging portions 211 and 212 are located on two sides of the storage portion 213. In this embodiment, the container 23 made of plastic connects to the main body 21 made of rubber via the connecting mechanism 22. The connecting mechanism 22 comprises a first connecting element 221 and a second connecting element 222. The first connecting element 221 comprises a plurality of protrusions 223. The protrusions 223 pass a plurality of holes 214 of the storage portion 213, and then pass through a plurality of apertures 224 of the second connecting element 222 for connecting the connecting mechanism 22 and the main body 21. The apertures 224 are shown by FIG. 6. The container 23 comprises a base 231 and a cover 232. The base 231 and the cover 232 are respectively installed on two sides of the connecting mechanism 22 and the base 231 connects to the cover 232. The edge 223 of the base 231 props a first propping end 226 (shown by FIG. 5) of the first connecting element 221. The edge 234 of the cover 232 props a second propping end 225 of the second connecting element 222. The ringlike storage portion enables rotation of the container 23. Moreover, the second connecting element 222 further comprises a hole 227 to provide the power line 32 to pass therethrough.

The invention provides a headset assembly which can be comfortably worn for a prolonged periods of time. Moreover, the power line 14 of the headset assembly is easily hidden. If a military, police officer or a security guard wears the headset assembly of the invention, the power line 14 is easily hidden to avoid detection.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A headset assembly, comprising a microphone and an earphone, comprising:
a main body comprising:
two hanging portions; and
a storage portion comprising a plurality of holes;
a connecting mechanism comprising:
a first connecting element, comprising a plurality of protrusions; and
a second connecting element, comprising a plurality of apertures;
a container comprising a base and a cover;
wherein the protrusions pass through the holes and are fixed in the apertures;
wherein the base is connected to the cover, and the connecting mechanism and the main body are located between the base and the cover; and
wherein the hanging portions are bent to change the shape and the size of the main body.

2. The headset assembly as claimed in claim 1, wherein the cover comprises a tube to connect to the microphone.

3. The headset assembly as claimed in claim 1, wherein the first connecting element further comprises a first propping end connected to the base, the second connecting element further comprises a second propping end connected to the cover, the container rotates on the first propping end and the second propping end.

4. The headset assembly as claimed in claim 1, wherein the storage portion is ringlike and the container rotates in the storage portion.

5. A headset assembly, comprising a microphone and an earphone, comprising:
a main body comprising:
a ringlike storage portion comprising a plurality of holes;
a connecting mechanism comprising:
a first connecting element, comprising a plurality of protrusions; and
a second connecting element, comprising a plurality of apertures;
a container comprising a base and a cover;
wherein the protrusions pass through the holes and are fixed in the apertures;
wherein the base is connected to the cover, and the connecting mechanism and the main body are located between the base and the cover; and
wherein the container rotates in the main body.

6. The headset assembly as claimed in claim 5, wherein the cover comprises a tube to connect to the microphone.

7. The headset assembly as claimed in claim 5, wherein the first connecting element further comprises a first propping end connected to the base, the second connecting element further comprises a second propping end connected to the cover, the container rotates on the first propping end and the second propping end.
